(19) United States
(12) Patent Application Publication
(10) Pub. No.: US 2006/0164510 A1
(43) Pub. Date: Jul. 27, 2006

(54) Sensor with narrow mounting profile

(76) Inventor: Doron Adler, Nesher (IL)

Correspondence Address: GANZ LAW, P.C., P O BOX 2200, HILLSBORO, OR, 97123, US

(21) Appl. No.: 11/042,625

(22) Filed: Jan. 24, 2005

(51) Int. Cl. H04N 7/18; A62B 1/04; H04N 9/47

(52) U.S. Cl. 348/65

(57) ABSTRACT

An electronic imaging device includes a printed circuit substrate having conductive traces disposed thereon and an image sensor mounted on the substrate. The image sensor has multiple sides and conductive interconnections, coupling the image sensor to the conductive traces on the printed circuit substrate, such that the interconnections are located on only one of the sides of the image sensor.

### FIELD OF THE INVENTION

The present invention relates generally to electronic imaging systems, and particularly to miniature camera heads and associated circuitry, especially for use in endoscopy.

### BACKGROUND OF THE INVENTION

Miniature, remote-head cameras are commonly used in endoscopy and other areas of minimally-invasive surgery. A solid-state imaging sensor is fixed in the distal end of an endoscope, along with suitable imaging optics and an illumination source, in order to capture images within body cavities and passageways. In general it is desirable to reduce the endoscope size and at the same time to improve the image quality obtained from the distal-end camera head. These two objectives are often mutually contradictory, since increasing the resolution of the sensor generally requires increasing its size, which leads to increasing the size of the endoscope.

A wide variety of distal-end camera heads have been described in the patent literature, based mainly on integration of the sensor, typically a CCD-based sensor, with suitable miniature optics. Some exemplary camera head designs are described in U.S. Pat. Nos. 4,604,992, 4,491,865, 4,746,203, 4,720,178, 5,166,787, 4,803,562, and 5,594,497. Some systems and methods for reducing the overall dimensions of the distal end of an endoscope containing an image sensor are described in U.S. Pat. Nos. 5,929,901, 5,986,693, 6,043,839, 5,376,960, and 4,819,065, and in U.S. Patent Application Publication No. 2001/0031912 A1.

One technique that has been suggested for reducing endoscope diameter is to orient the image sensor in a plane that is parallel to the axis of the imaging optics, rather than perpendicular to the plane as in conventional optical designs. Implementations of this technique are described in U.S. Pat. Nos. 4,692,608, 4,646,721 and 4,986,642 and in the above-mentioned U.S. Patent Application Publication US 2001/0031912 A1. The disclosures of all the above publications are incorporated herein by reference.

Various techniques are known in the art for mounting an image sensor on a printed circuit board (PCB) and handling the required electrical interconnections between the sensor and other circuit elements. For example, PCT Patent Publication WO 03/098913, entitled “Miniature Camera Head,” whose disclosure is incorporated herein by reference, describes several mounting configurations that can be used to minimize the size of an endoscope containing such an image sensor.

U.S. Pat. No. 5,712,493, whose disclosure is incorporated herein by reference, describes methods for mounting a display device onto a substrate board and handling the related interconnections. Several interconnection schemes are shown, arranging interconnection lines along two or three sides of the device, with the aim of making the peripheral portion of the substrate, on which driving elements are mounted, more compact.

### SUMMARY OF THE INVENTION

Embodiments of the present invention provide a novel technique for mounting an image sensor on a printed circuit substrate. An unpackaged sensor chip is mounted on the substrate in such a way that all input and output interconnections with the sensor chip are located along one side of the sensor chip. In one embodiment, the connections are made by wire bonding, but alternative connection methods will be apparent to those skilled in the art. Locating all interconnections along a single side enables positioning of the remaining three sides of the sensor chip in close proximity to the edges of the substrate. Using this technique, the width of a miniature camera head assembly may be made almost as narrow as the width of the sensor chip, and the length of the assembly may be minimized.

In some embodiments of the present invention, a miniature camera head assembly of this sort is used in an endoscopic imaging system. The camera head assembly comprises an objective for collecting optical radiation from an object, and an image sensor, which is typically parallel to the optical axis. A turning mirror, typically a prism, directs the radiation collected by the objective to form a focused image on the image sensor. The image sensor is mounted on and connected to a printed circuit board in the manner described above. As a result, the diameter of the endoscope need be no greater than the width of the image sensor itself. Minimizing the length of the camera head assembly improves the insertion flexibility of the endoscope, enabling it to penetrate narrow and winding passageways.

Embodiments of the present invention may additionally be used in other imaging applications in which size and weight are at a premium, such as in military and surveillance cameras and industrial cameras for diagnostics of small cavities.

There is therefore provided, in accordance with an embodiment of the present invention, an electronic imaging device, including a printed circuit substrate having conductive traces disposed thereon, an image sensor mounted on the substrate, the image sensor having multiple sides, and conductive interconnections, coupling the image sensor to the conductive traces on the printed circuit substrate, such that the interconnections are located on only one of the sides of the image sensor.

In a disclosed embodiment, the conductive interconnections include wire-bonds.

In another embodiment, the interconnections are located on a first side of the image sensor, and a second side of the image sensor, opposite the first side, is positioned less than 0.5 mm from an edge of the printed circuit substrate.

Additionally or alternatively, the substrate has a first width, and the image sensor has a second width, and the first width is no more than 0.2 mm greater than the second width.

In still another embodiment, the printed circuit substrate includes a recess for accommodating the image sensor.

In yet another embodiment, the image sensor-includes a semiconductor chip, which is fixed directly to the substrate.

There is further provided, in accordance with an embodiment of the present invention, an image sensor device, including a semiconductor substrate having multiple sides, an array of light sensing elements disposed on the substrate and contact pads located on only one of the sides of the semiconductor substrate, for coupling the array of light sensing elements to circuitry external to the image sensing device.

In a disclosed embodiment, the contact pads are connected to a printed circuit substrate by wire bonding.

There is further provided, in accordance with an embodiment of the present invention, an endoscope including an insertion tube having a distal end and an imaging assembly disposed in the distal end of the insertion tube, the imaging assembly including:

a printed circuit substrate having conductive traces disposed thereon;

an image sensor mounted on the substrate, the image sensor having multiple sides; and

conductive interconnections, coupling the image sensor to the conductive traces on the printed circuit substrate, such that the interconnections are located on only one of the sides of the image sensor; and

an optical objective for collecting optical radiation from an object outside the distal end of the insertion tube and focusing the optical radiation onto the image sensor.

In a disclosed embodiment, the optical objective has an optical axis, and the image sensor includes a matrix of optical detectors arranged in a plane that is non-perpendicular to the optical axis.

In another embodiment, the endoscope includes an optical surface that is positioned so as to reflect the radiation collected by the objective in order to form a focused image in the plane of the image sensor.

There is still further provided, in accordance with an embodiment of the present invention, a method for producing an imaging device, including forming an array of light sensing elements on a semiconductor substrate having multiple sides, and forming contact pads on only one of the sides of the semiconductor substrate, for coupling the array of light sensing elements to circuitry external to the semiconductor substrate.

In a disclosed embodiment, the method includes fixing the semiconductor substrate to a printed circuit substrate having conductive traces disposed thereon, and connecting the contact pads to the conductive traces using interconnections on only the one of the sides of the semiconductor substrate.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an endoscopic imaging system, in accordance with an embodiment of the present invention;

FIG. 2 is a schematic, sectional diagram of a camera head assembly, in accordance with an embodiment of the present invention; and

FIG. 3 is a schematic top view of a sensor assembly used in a camera head, in accordance with an embodiment of the present invention.

### DETAILED DESCRIPTION OF EMBODIMENTS

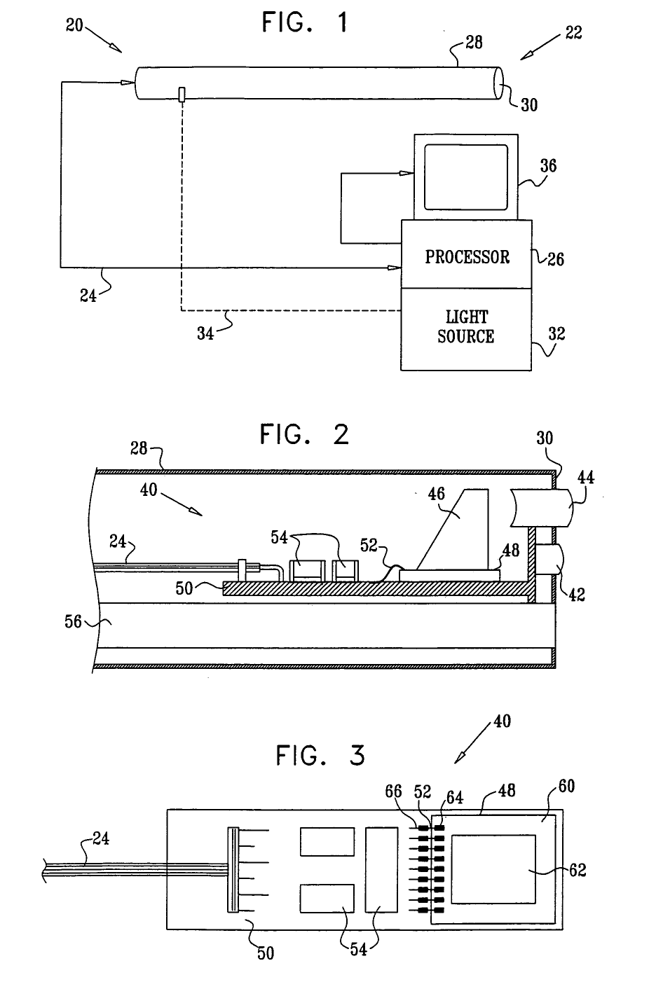

FIG. 1 is a block diagram that schematically illustrates an endoscopic imaging system 20, in accordance with an embodiment of the present invention. System 20 comprises an endoscope 22, which is connected by a cable 24 to a processing unit 26. The endoscope comprises an insertion tube 28, containing a miniature camera head at its distal end 30, as shown and described hereinbelow. Typically, the endoscope also contains an internal light source, for illuminating the area adjacent to the distal end of the endoscope, which is imaged by the camera head. Alternatively or additionally, an external light source 32 may be used to provide illumination via a fiberoptic bundle 34 to a light guide within endoscope 22. Further details of an endoscopic system of this sort are described in the above-mentioned PCT Patent Publication WO 03/098913.

FIG. 2 is a schematic, sectional illustration showing a miniature camera head assembly 40 within insertion tube 28, in accordance with an embodiment of the present invention. One or more light sources 42, typically comprising LEDs, illuminate the region immediately distal to endoscope 22. An optical objective 44, mounted at distal end 30, collects and focuses light from objects illuminated by light source 42. A turning mirror, typically comprising a right angle prism 46, reflects the light collected by objective 44 to focus on the focal plane of an image sensor 48. Sensor 48 typically comprises a two-dimensional matrix of detector elements, based on CMOS, CCD or other solid-state imaging technology, as is known in the art. Typically, the focal plane of the sensor is parallel to the optical axis of objective 44. Alternatively, the turning mirror and image sensor may be arranged so that the sensor is oriented at a different angle, perpendicular or non-perpendicular to the optical axis of the objective.

Sensor 48 is mounted on a circuit substrate 50, typically a printed circuit board (PCB). The circuit substrate is typically made of standard “FR4” PCB material, as is known in the art. Alternatively, ceramic or glass-based substrate materials may also be used. In embodiments of the present invention, the sensor is mounted onto the substrate as an unpackaged chip using a suitable adhesive material, as is known in the art.

In one embodiment, a suitable recess is cut in the substrate to accommodate the sensor chip and thus reduce the thickness of the electronic portion of assembly 40. Alternatively, the sensor is mounted directly onto the substrate with no recess.

Typically, all electrical interconnections between sensor 48 and the circuitry residing on substrate 50 are implemented using wire bonds 52. All interconnecting wires are located along a single side of the sensor in order to minimize any additional substrate area around the sensor and limit such overhead area to one side only. Other types of electrical interconnections with the sensor may be used, as will be apparent to those skilled in the art, as long as all interconnections are physically located along a single side of the sensor.

Cable 24 passing through endoscope 22 connects assembly 40 to processing unit 26. One or more controller and communication interface chips 54 on substrate 50 serve to pass electrical signals from image sensor 48 to processing unit 26 and to receive control inputs from the processing unit. A working channel 56, which runs substantially the entire length of endoscope 22, is typically located beneath substrate 50.

FIG. 3 is a schematic top view of a part of camera head assembly 40, in accordance with an embodiment of the present invention. As noted above, image sensor 48 is mounted on substrate 50 as an unpackaged chip. The image sensor comprises a rectangular semiconductor substrate 60, on which a matrix of light sensing elements 62 is formed. Contact pads 64 are connected by wire bonds 52 to conductive traces 66 on substrate 50, thus linking the image sensor to the circuitry residing on substrate 50. The contact pads and wire bonds are located along a single side of semiconductor substrate 60.

Note that the total width of substrate 50 is typically no more than 20% wider than sensor 48, and may even be less than 10% wider than the image sensor. (Typically, substrate 50 extends 0.2 mm or less on either side of the sensor.) (Here the width dimension is the vertical direction in FIG. 3.) Thus, the diameters of the entire camera head assembly 40 and of endoscope 22 are minimized. Note also that sensor 48 is located in close proximity to the right edge of substrate 50 (typically to within 0.5 mm from the edge), thus minimizing the length of the entire camera head assembly 40. As a result, only a short section at the distal end of endoscope 22 need be made rigid, in order to accommodate the camera head assembly, while the rest of the endoscope may be as flexible as desired.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. An electronic imaging device, comprising:
a printed circuit substrate having conductive traces disposed thereon;
an image sensor mounted on the substrate, the image sensor having multiple sides; and
conductive interconnections, coupling the image sensor to the conductive traces on the printed circuit substrate, such that the interconnections are located on only one of the sides of the image sensor.

2. The device according to claim 1, wherein the conductive interconnections comprise wire-bonds.

3. The device according to claim 1, wherein the interconnections are located on a first side of the image sensor, and wherein a second side of the image sensor, opposite the first side, is positioned less than 0.5 mm from an edge of the printed circuit substrate.

4. The device according to claim 1, wherein the substrate has a first width, and the image sensor has a second width, and wherein the first width is no more than 0.2 mm greater than the second width.

5. The device according to claim 1, wherein the printed circuit substrate comprises a recess for accommodating the image sensor.

6. The device according to claim 1, wherein the image sensor comprises a semiconductor chip, which is fixed directly to the substrate.

7. An image sensor device, comprising:
a semiconductor substrate having multiple sides;
an array of light sensing elements disposed on the substrate; and
contact pads located on only one of the sides of the semiconductor substrate, for coupling the array of light sensing elements to circuitry external to the image sensing device.

8. The device according to claim 7, wherein the contact pads are adapted to be connected to a printed circuit substrate by wire bonding.

9. An endoscope comprising:
an insertion tube having a distal end; and
an imaging assembly disposed in the distal end of the insertion tube, the imaging assembly comprising:
a printed circuit substrate having conductive traces disposed thereon;
an image sensor mounted on the substrate, the image sensor having multiple sides; and
conductive interconnections, coupling the image sensor to the conductive traces on the printed circuit substrate, such that the interconnections are located on only one of the sides of the image sensor; and
an optical objective for collecting optical radiation from an object outside the distal end of the insertion tube and focusing the optical radiation onto the image sensor.

10. The endoscope according to claim 9, wherein the optical objective has an optical axis, and wherein the image sensor comprises a matrix of optical detectors arranged in a plane that is non-perpendicular to the optical axis.

11. The endoscope according to claim 10, and comprising an optical surface that is positioned so as to reflect the radiation collected by the objective in order to form a focused image in the plane of the image sensor.

12. The endoscope according to claim 9, wherein the conductive interconnections comprise wire-bonds.

13. The endoscope according to claim 9, wherein the conductive interconnections are located on a first side of the image sensor, and wherein a second side of the image sensor, opposite the first side, is positioned less than 0.5 mm from an edge of the printed circuit substrate.

14. The endoscope according to claim 9, wherein the substrate has a first width, and the image sensor has a second width, and wherein the first width is no more than 0.2 mm greater than the second width.

15. A method for producing an imaging device, comprising:
forming an array of light sensing elements on a semiconductor substrate having multiple sides; and
forming contact pads on only one of the sides of the semiconductor substrate, for coupling the array of light sensing elements to circuitry external to the semiconductor substrate.

16. The method according to claim 15, and comprising fixing the semiconductor substrate to a printed circuit substrate having conductive traces disposed thereon, and connecting the contact pads to the conductive traces using interconnections on only the one of the sides of the semiconductor substrate.

17. The method according to claim 16, wherein connecting the contact pads to the conductive traces comprises bonding wires between the contact pads and the conductive traces.

18. The method according to claim 16, wherein the contact pads are located on a first side of the semiconductor substrate, and wherein fixing the semiconductor substrate to the printed circuit substrate comprises locating a second side of the semiconductor substrate, which is opposite the first side, less than 0.5 mm from an edge of the printed circuit substrate.

19. The method according to claim 16, and comprising fixing the semiconductor substrate to a printed circuit substrate having a first width, the semiconductor substrate having a second width, and wherein the first width is no more than 0.2 mm greater than the second width.

20. The method according to claim 16, wherein fixing the semiconductor substrate to the printed circuit substrate comprises inserting the substrate in a recess in the printed circuit substrate.
